(19) United States
(12) Patent Application Publication
(10) Pub. No.: US 2014/0048227 A1
(43) Pub. Date: Feb. 20, 2014

(54) VEHICLE AIR CONDITIONING DEVICE

(71) Applicant: Masakazu Saitou, Isesaki-shi (JP)

(72) Inventor: Masakazu Saitou, Isesaki-shi (JP)

(21) Appl. No.: 13/879,337

(22) PCT Filed: Oct. 3, 2011
(86) PCT No.: PCT/JP2011/072747

§ 371 Date: Sep. 25, 2013

(30) Foreign Application Priority Data
Oct. 14, 2010 (JP) 2010-231141

(51) Int. Cl. B60H 1/00

(52) U.S. Cl. CPC B60H 1/00028
USPC 165/48.1

(57) ABSTRACT

A vehicle air conditioning device comprises first and second outside air ventilation flues that are formed so that outside air flows through opposing ends of an evaporator. An inside air ventilation flue is formed so that inside air flows through a central site in the evaporator such that, at any degree of opening of a first damper, outside air from each of the outside air ventilation flues and inside air from the inside air ventilation flue can flow to an outlet-side ventilation flue or a heater-side ventilation flue at a flow rate that corresponds to the degree of opening of the first damper. Accordingly, even in a configuration in which outside air and inside air flow to the evaporator, it is not necessary to provide the first damper that opens/closes a downstream side of the evaporator for each of the outside air and inside air flow sections.

### TECHNICAL FIELD

The present invention relates to a vehicle air conditioning device that performs cooling and heating inside the cabin of an automobile.

### BACKGROUND ART

A conventional vehicle air conditioning device of this kind is known that includes a blower unit that sucks in outside air (air outside the vehicle cabin) and inside air (air inside the vehicle cabin), and an air conditioning unit that cools or heats air that is sent from the blower unit and blows out the cooled or heated air into the cabin, in which the blower unit is disposed on one side of the air conditioning unit (for example, see Patent Literature 1).

The blower unit includes a blower fan that sucks in outside air, and a blower fan that sucks in inside air, and is configured to blow each of the outside air and the inside air to the air conditioning unit through a duct. In this case, an outside air ventilation flue and an inside air ventilation flue are provided in an upper part and a lower part of the duct of the blower unit, respectively, and a configuration is adopted so that the outside air and the inside air from the blower unit flow to the air conditioning unit from one side in the width direction of the vehicle towards the other side by means of the duct.

The air conditioning unit includes: an outside air ventilation flue through which outside air that is sucked in from outside a cabin of a vehicle flows; an inside air ventilation flue through which inside air that is sucked in from inside the cabin of the vehicle flows; an evaporator that is disposed on a downstream side of the outside air ventilation flue and the inside air ventilation flue; an outlet-side ventilation flue through which air that flows out from the evaporator flows; a heater that is disposed on a downstream side of the evaporator; a heater-side ventilation flue that causes air that flows out from the evaporator to flow to the outlet-side ventilation flue via the heater; and a damper that opens/closes a flow path of air that flows directly to the outlet-side ventilation flue from the evaporator and a flow path of air that flows to the outlet-side ventilation flue via the heater-side ventilation flue from the evaporator, respectively.

The above described damper is formed so as to span the evaporator in the width direction on the downstream side of the evaporator, and is configured so as to open/close a flow path on the downstream side of the evaporator by rotating around a shaft that extends in the width direction of the evaporator. In this case, because the outside air of the outside air ventilation flue flows out from an upper portion of the evaporator and the inside air of the inside air ventilation flue flows out from a lower portion of the evaporator, a damper that opens/closes the upper side of the evaporator and a damper that opens/closes the lower side of the evaporator are respectively provided on the downstream side of the evaporator, and the respective dampers are configured so as to open/close in synchrony so that the respective degrees of opening of the dampers are equal.

### CITATION LIST

### Patent Literature

Patent Literature 1: Japanese Patent No. 3309779

### SUMMARY OF INVENTION

### Technical Problem

However, in the above described vehicle air conditioning device, because a damper that opens/closes the downstream side of the evaporator is provided for each of the outside air and inside air flow sections, respectively, there is the problem that the number of dampers increases, which complicates the structure and leads to an increase in the manufacturing cost.

The present invention has been made in view of the above described problem, and an object of the present invention is to provide a vehicle air conditioning device in which the number of dampers that open/close a lower side of an evaporator can be reduced, even in a configuration that causes outside air and inside air to flow to an evaporator, respectively.

### Solution to Problem

To achieve the above described object, a vehicle air conditioning device according to the present invention includes: an outside air ventilation flue through which outside air that is sucked in from outside a cabin of the vehicle flows; an inside air ventilation flue through which inside air that is sucked in from inside the cabin of the vehicle flows; an evaporator that is disposed on a downstream side of the outside air ventilation flue and the inside air ventilation flue; an outlet-side ventilation flue through which air that flows out from the evaporator flows; a heater that is disposed on a downstream side of the evaporator; a heater-side ventilation flue that causes air that flows out from the evaporator to flow via the heater to the outlet-side ventilation flue; and a damper that is formed so as to span the evaporator in a width direction on the downstream side of the evaporator, and that, by rotating around a shaft extending in the width direction of the evaporator, opens/closes a flow path of air that flows directly to the outlet-side ventilation flue from the evaporator and a flow path of air that flows from the evaporator via the heater-side ventilation flue to the outlet-side ventilation flue, respectively; wherein the outside air ventilation flue is formed so that the outside air flows to a predetermined position in the width direction of the evaporator, and the inside air ventilation flue is formed so that the inside air flows to another predetermined position in the width direction of the evaporator.

Thus, in a configuration in which a damper that opens/closes a downstream side of an evaporator is formed so as to span the evaporator in the width direction, and rotates around a shaft that extends in the width direction of the evaporator, because outside air flows to a predetermined position in the width direction of the evaporator and inside air flows to another predetermined position in the width direction of the evaporator, at any degree of opening of the damper, outside air from the outside air ventilation flue and inside air from the inside air ventilation flue each flow to the downstream side of the evaporator at a flow rate that corresponds to the degree of opening of the damper. Therefore, even in a configuration that causes outside air and inside air to each flow to an evaporator, it is not necessary to provide a damper that opens/closes the downstream side of the evaporator for each of the outside air and inside air flow sections, respectively.

### Advantageous Effects of Invention

According to the present invention, even in a configuration that causes outside air and inside air to flow to an evaporator, respectively, since it is not necessary to provide a damper that opens/closes the downstream side of the evaporator for each of the outside air and inside air flow sections, respectively, the number of dampers can be reduced, and thus the structure can be simplified and the manufacturing cost can be lowered.

### BRIEF DESCRIPTION OF DRAWINGS

FIG. 1 is a schematic plan view of a vehicle air conditioning device that illustrates one embodiment of the present invention.

FIG. 2 is a perspective view of a principal portion of the vehicle air conditioning device.

FIG. 3 is a schematic planar cross-sectional view of an air conditioning unit.

FIG. 4 is a schematic front view of the air conditioning unit.

FIG. 5 is a side cross-sectional view of the air conditioning unit as viewed in the direction of an arrow line A-A in FIG. 3.

FIG. 6 is a side cross-sectional view of the air conditioning unit as viewed in the direction of an arrow line B-B in FIG. 3.

FIG. 7 is a side cross-sectional view of the air conditioning unit as viewed in the direction of an arrow line C-C in FIG. 3.

FIG. 8 is a schematic perspective view of outside air ventilation flues and an inside air ventilation flue.

FIG. 9 is a schematic perspective view of the outside air ventilation flues and the inside air ventilation flue that illustrates a flow state of outside air and inside air.

FIG. 10 is a side cross-sectional view of the air conditioning unit that illustrates a face mode.

FIG. 11 is a side cross-sectional view of the air conditioning unit that illustrates a top/bottom temperature difference mode.

FIG. 12 is a side cross-sectional view of the air conditioning unit that illustrates a foot mode.

FIG. 13 is a side cross-sectional view of the air conditioning unit that illustrates a defroster mode.

FIG. 14 is a side cross-sectional view of the air conditioning unit that illustrates a foot/defroster mode.

FIG. 15 is a schematic planar cross-sectional view of an air conditioning unit that shows another embodiment of the present invention.

FIG. 16 is a schematic front view of an air conditioning unit.

### DESCRIPTION OF EMBODIMENTS

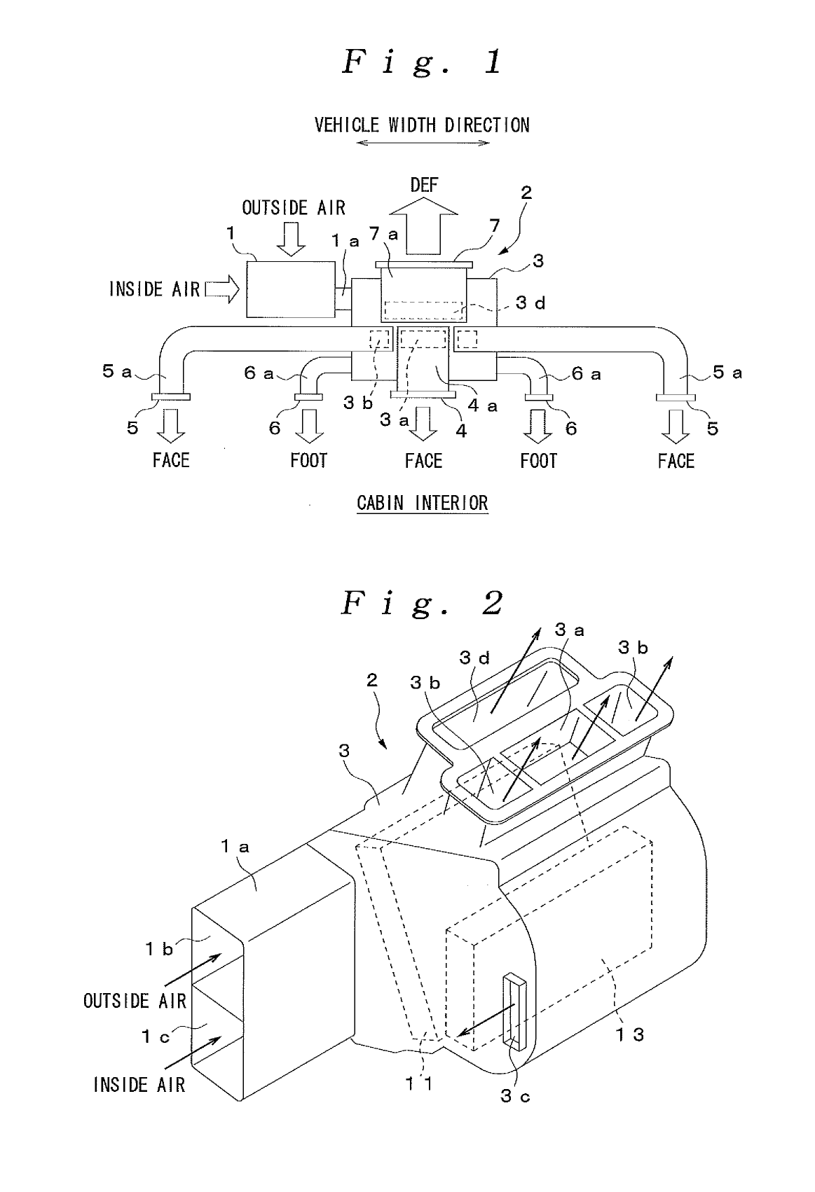

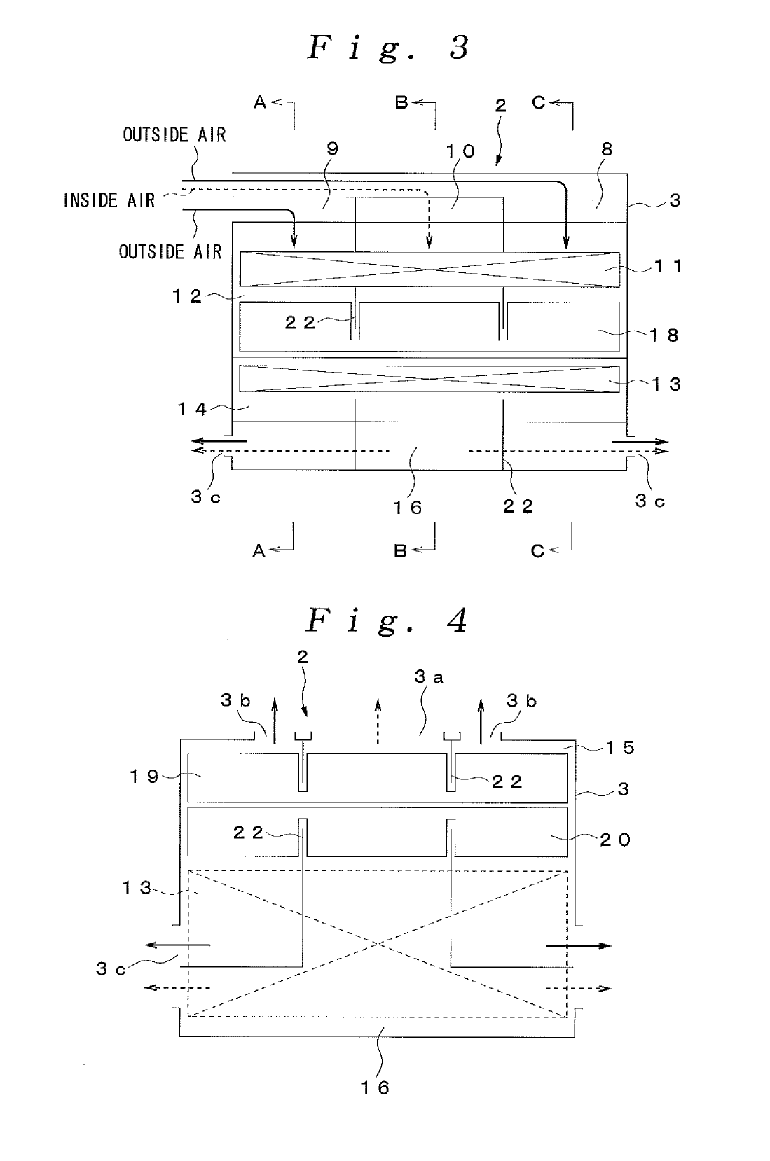

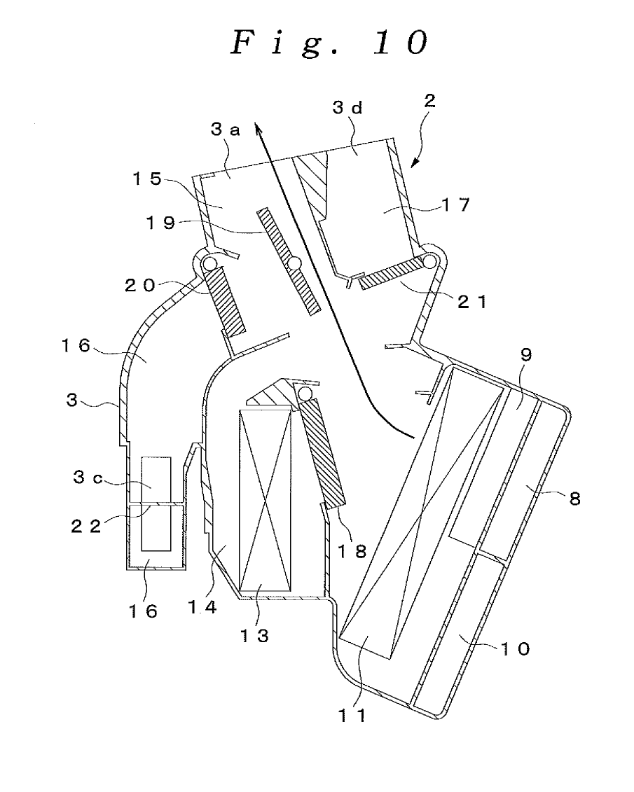

FIGS. 1 to 14 show an embodiment of the present invention.

A vehicle air conditioning device of the present embodiment includes a blower unit 1 that sucks in outside air (air outside the vehicle cabin) and inside air (air inside the vehicle cabin) and an air conditioning unit 2 that cools or heats air that is sent from the blower unit 1 and blows out the cooled or heated air into the cabin, in which the blower unit 1 is disposed on one side of the air conditioning unit 2.

Although not shown in the drawings, the blower unit 1 includes a blower fan that sucks in outside air and a blower fan that sucks in inside air, and is configured to blow the outside air and the inside air to the air conditioning unit 2 through a duct 1a, respectively. In this case, a single upper ventilation flue 1b through which outside air flows and a single lower ventilation flue 1c through which inside air flows are provided at an upper part and a lower part, respectively, of the duct la of the blower unit 1, and a configuration is adopted so that outside air and inside air from the blower unit 1 flow from one side towards the other side in the width direction of the vehicle to the air conditioning unit 2 by means of the duct 1a.

The air conditioning unit 2 includes a unit body 3 having a hollow shape that is formed so that air can flow through the inside thereof. The unit body 3 is connected to a first face air outlet 4, second face air outlets 5, foot air outlets 6 and a defroster air outlet 7 that open inside the cabin, through ducts 4a, 5a, 6a, and 7a, respectively. In this case, the first face air outlet 4 is provided at a central site in the width direction inside the cabin as a first air outlet, and is configured to blow out air mainly between the driver's seat and the front passenger seat. The second face air outlets 5 are provided on each side in the width direction inside the cabin as second air outlets, and are configured to blow out air mainly on the door glass side of the driver's seat and the front passenger seat. The foot air outlets 6 are respectively disposed at two places in the width direction inside the cabin, and are configured to blow out air mainly into foot space at the driver's seat and the front passenger seat. The defroster air outlet 7 is disposed at the central site in the width direction inside the cabin, and is configured to blow out air on the inner side of the windshield.

Inside the unit body 3 are provided: first and second outside air ventilation flues 8 and 9 through which outside air that is blown from the blower unit 1 flows; an inside air ventilation flue 10 through which inside air that is blown from the blower unit 1 flows; an evaporator 11 that is disposed on a downstream side of the respective outside air ventilation flues 8 and 9 and the inside air ventilation flue 10; an outlet-side ventilation flue 12 through which air that flows out from the evaporator 11 flows; a heater 13 that is disposed on a downstream side of the evaporator 11; a heater-side ventilation flue 14 that causes air that flows out from the evaporator 11 to flow to the outlet-side ventilation flue 12 via the heater 13; a face-side ventilation flue 15 through which air of the outlet-side ventilation flue 12 flows out to the side of the respective face air outlets 4 and 5; a foot-side ventilation flue 16 through which air of the outlet-side ventilation flue 12 flows out to the side of the respective foot air outlets 6; a defroster-side ventilation flue 17 through which air of the outlet-side ventilation flue 12 flows out to the side of the defroster air outlet 7; a first damper 18 that opens/closes a flow path of air that flows directly to the outlet-side ventilation flue 12 from the evaporator 11 and a flow path of air that flows from the evaporator 11 via the heater-side ventilation flue 14 to the outlet-side ventilation flue 12, respectively; a second damper 19 that regulates a flow amount of air that flows out from the outlet-side ventilation flue 12 to the face-side ventilation flue 15; a third damper 20 that regulates a flow amount of air that flows out from the outlet-side ventilation flue 12 to the foot-side ventilation flue 16; and a fourth damper 21 that regulates a flow amount of air that flows out from the outlet-side ventilation flue 12 to the defroster-side ventilation flue 17.

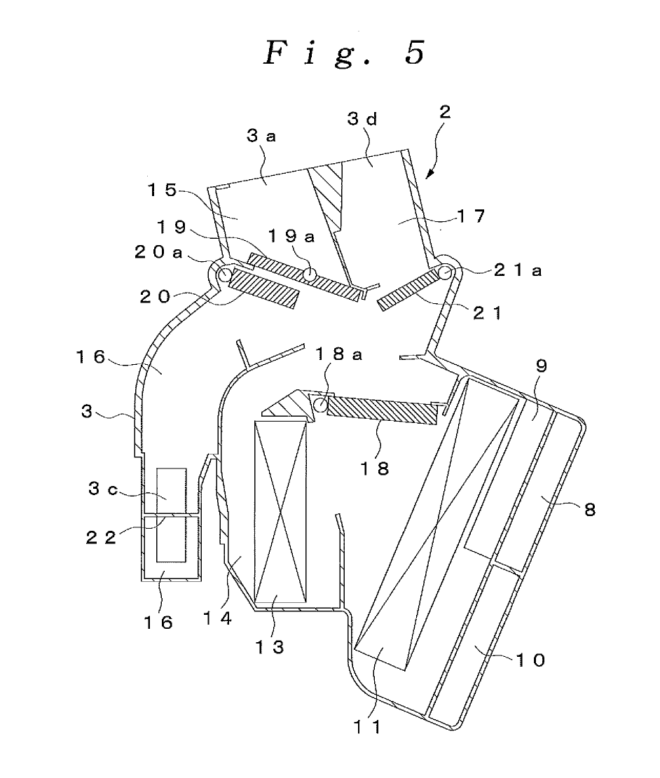

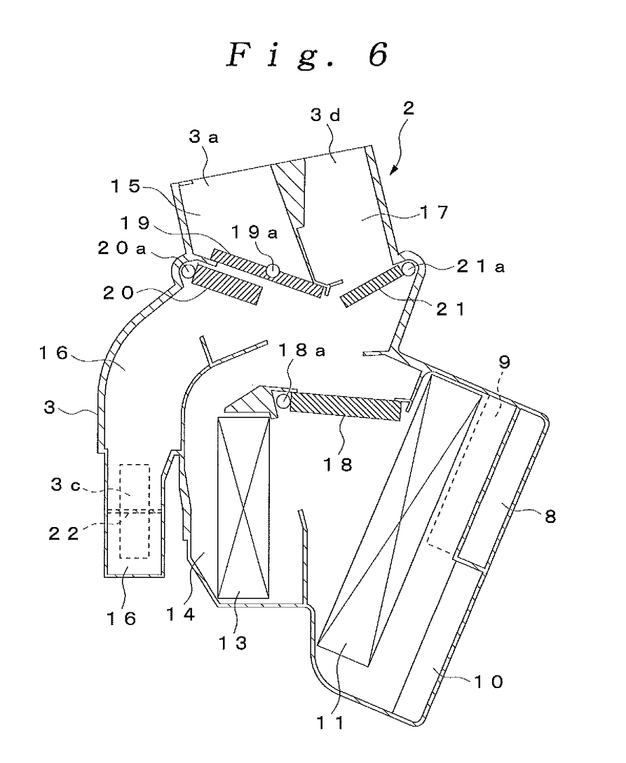

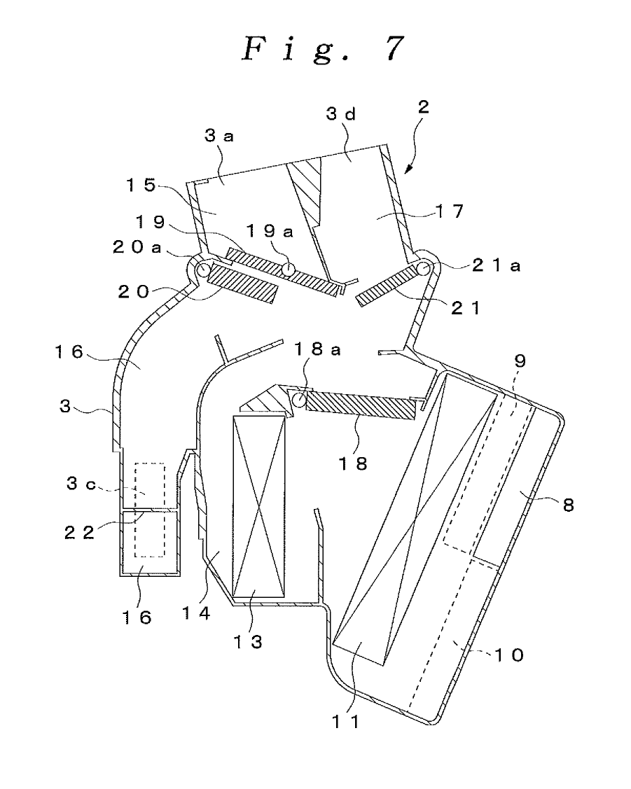

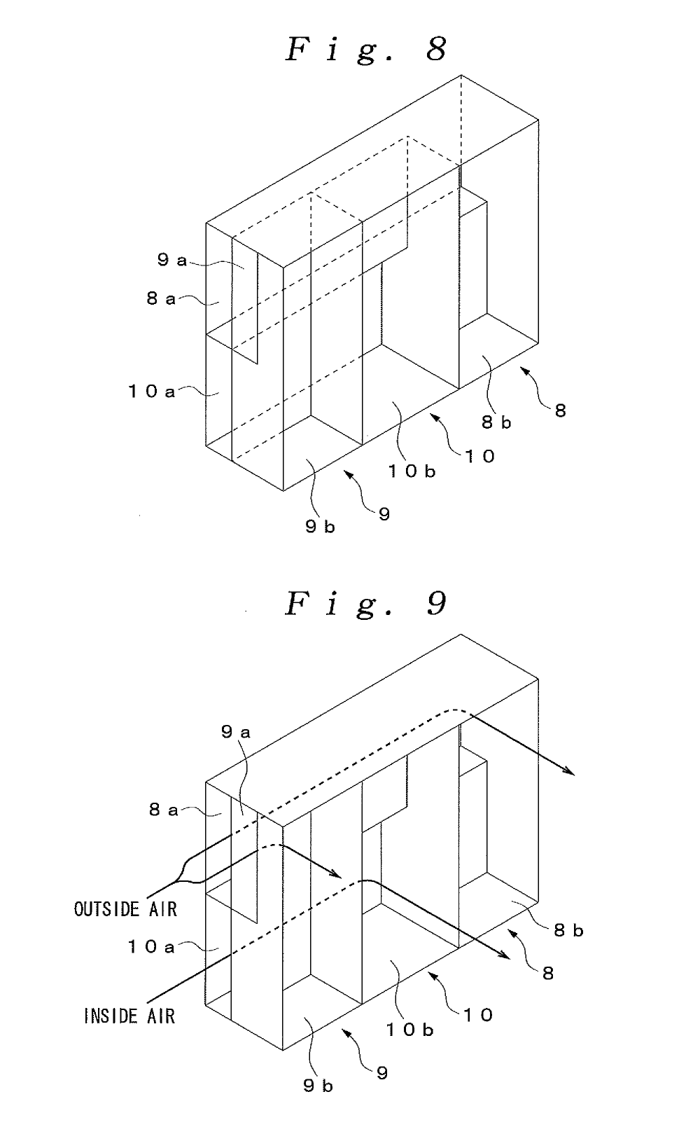

As shown in FIG. 8, in the first outside air ventilation flue 8, an air inflow-side ventilation flue 8a is formed so as to extend in a width direction of the unit body 3 (width direction of the vehicle), and an air outflow-side ventilation flue 8b is open from the top to the bottom from one end side in the width direction of the unit body 3 towards the inner side of the unit body 3 (rear of the vehicle).

As shown in FIG. 8, in the second outside air ventilation flue 9, an air inflow port 9a is disposed on the inner side of the unit body 3 relative to the first outside air ventilation flue 8, and an air outflow-side ventilation flue 9b is open from the top to the bottom from the other end side in the width direction of the unit body 3 towards the inner side of the unit body 3.

As shown in FIG. 8, in the inside air ventilation flue 10, an air inflow-side ventilation flue 10a extends in the width direction of the unit body 3 (width direction of vehicle) and is disposed below the first outside air ventilation flue 8, and an air outflow-side ventilation flue 10b is open from the top to the bottom from a center end site (between the air outflow-side ventilation flues 8b and 9b) in the width direction of the unit body 3 towards the inner side of the unit body 3.

The respective outside air ventilation flues 8 and 9 and the inside air ventilation flue 10 are formed in a flattened shape so that a width thereof in the front-and-rear direction of the vehicle is less than a dimension thereof in the vertical direction, and the first outside air ventilation flue 8 and the second outside air ventilation flue 9 are provided so as to adjoin each other in the front-and-rear direction of the vehicle. Thus, the first and second outside air ventilation flues 8 and 9 of the unit body 3 communicate with the upper ventilation flue 1b of the duct 1a, and the inside air ventilation flue 10 of the unit body 3 communicates with the lower ventilation flue 1c of the duct 1a.

That is, outside air that is blown from the blower unit 1 flows out to one end side and the other end side in the width direction of the evaporator 11 from the first and second outside air ventilation flues 8 and 9, and inside air that is blown from the blower unit 1 flows out to the central site in the width direction of the evaporator 11 from the inside air ventilation flue 10.

In addition, the outlet-side ventilation flue 12, the heater-side ventilation flue 14, the face-side ventilation flue 15 and the foot-side ventilation flue 16 are partitioned in the width direction by partition walls 22 so as to correspond to the air outflow-side ventilation flue 8b of the first outside air ventilation flue 8, the air outflow-side ventilation flue 9b of the second outside air ventilation flue 9, and the air outflow-side ventilation flue 10b of the inside air ventilation flue 10, respectively. In this case, a ventilation flue at the central site in the width direction inside the face-side ventilation flue 15 communicates with a duct 4a of the first face air outlet 4 through a first opening portion 3a of the unit body 3, and ventilation flues on one end side and the other end side in the width direction inside the face-side ventilation flue 15 communicate with ducts 5a of the second face air outlets 5 on the left and right sides through second opening portions 3b of the unit body 3, respectively. Ventilation flues on one end side and the other end side in the width direction inside the foot-side ventilation flue 16 communicate with ducts 6a of the foot air outlets 6 on the left and right sides through third opening portions 3c of the unit body 3, respectively. A ventilation flue at the central site in the width direction inside the foot-side ventilation flue 16 branches to the left and right and communicates with the ducts 6a of the foot air outlets 6 on the left and right sides through the third opening portions 3c of the unit body 3. Further, the defroster-side ventilation flue 17 communicates with a duct 7a of the defroster air outlet 7 through a fourth opening portion 3d of the unit body 3.

The evaporator 11 is configured so that, by circulating low temperature refrigerant by means of a compressor of a refrigeration circuit that is not shown in the drawings, air that flows through the evaporator 11 is cooled by heat-exchange with the low temperature refrigerant.

The heater 13 is configured so that, by circulating cooling water of a radiator of the vehicle by means of an unshown pump, air that flows through the heater 13 is heated by heat-exchange with the cooling water.

The first damper 18 is formed so as to span the evaporator 11 in the width direction, and is rotatably supported by a spindle 18a that extends in the width direction of the evaporator 11. The first damper 18 is configured to be rotated by an unshown motor so as to open/close an air inflow side of the outlet-side ventilation flue 12 (downstream side of the evaporator 11) and an air inflow side of the heater-side ventilation flue 14 (downstream side of the evaporator 11), respectively. In this case, by rotating the first damper 18 to an arbitrary intermediate position, it is possible for air to flow at an arbitrary flow rate in both the outlet-side ventilation flue 12 and the heater-side ventilation flue 14, respectively.

The second damper 19 is rotatably supported by a spindle 19a, and is configured to be rotated by an unshown motor so as to open/close the face-side ventilation flue 15.

The third damper 20 is rotatably supported by a spindle 20a, and is configured to be rotated by an unshown motor so as to open/close the foot-side ventilation flue 16.

The fourth damper 21 is rotatably supported by a spindle 21a, and is configured to be rotated by an unshown motor so as to open/close the defroster-side ventilation flue 17.

In the air conditioning device configured as described above, air that is blown from the blower unit 1 is cooled or heated by the air conditioning unit 2 in accordance with an operation mode that is described later, and is blown out into the cabin from the air conditioning unit 2. Although air that is blown from the blower unit 1 to the air conditioning unit 2 flows from one side towards the other side in the width direction of the vehicle (width direction of the air conditioning unit 2), the flow direction thereof is changed to the front-and-rear direction of the vehicle by the respective outside air ventilation flues 8 and 9 and the inside air ventilation flue 10 of the air conditioning unit 2, and the air flows out towards the evaporator 11.

Further, although the first damper 18 that opens/closes the downstream side of the evaporator 11 is formed so as to span the evaporator 11 in the width direction and rotates around the spindle 18a that extends in the width direction of the evaporator 11, because the outside air of the first and second outside air ventilation flues 8 and 9 flows through one end side and the other end side in the width direction of the evaporator 11, respectively, and the inside air of the inside air ventilation flue 10 flows through the central site in the width direction of the evaporator 11, at any degree of opening of the first damper 18, the outside air from the respective outside air ventilation flues 8 and 9 and the inside air from the inside air ventilation flue 10 flow to the outlet-side ventilation flue 12 side or the heater-side ventilation flue 14 side at a flow rate that corresponds to the degree of opening of the first damper 18, respectively.

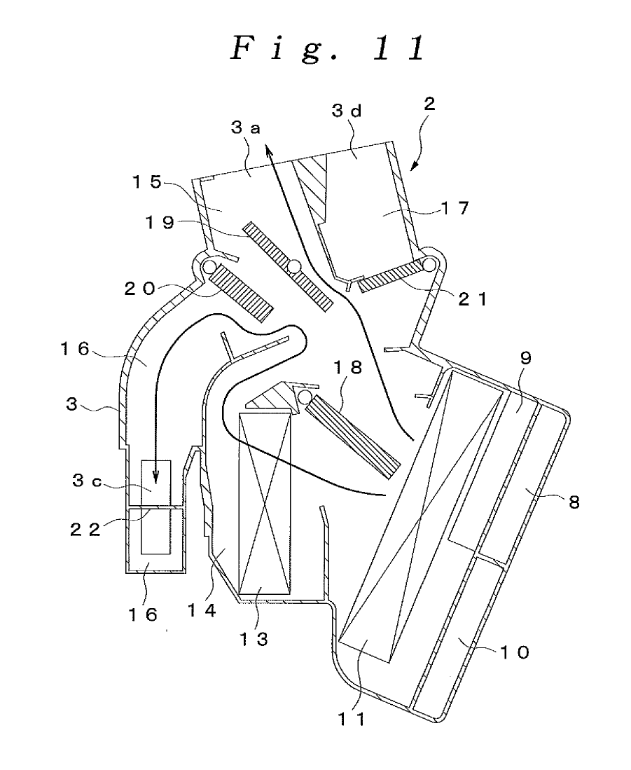

In a face mode, as shown in FIG. 10, the outlet-side ventilation flue 12 is opened and the heater-side ventilation flue 14 is closed by the first damper 18, the face-side ventilation flue 15 is opened by the second damper 19, the foot-side ventilation flue 16 is closed by the third damper 20, and the defroster-side ventilation flue 17 is closed by the fourth damper 21. As a result, air that was cooled by the evaporator 11 flows to the face-side ventilation flue 15 from the outlet-side ventilation flue 12 and is blown out into the cabin from the first and second face air outlets 4 and 5.

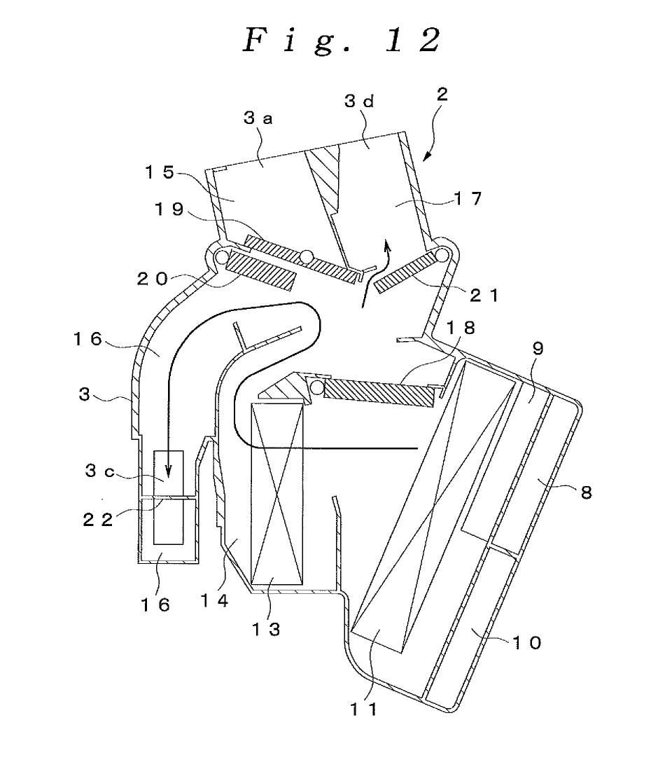

In a top/bottom temperature difference mode, as shown in FIG. 11, the outlet-side ventilation flue 12 and the heater-side ventilation flue 14 are each opened by the first damper 18, the face-side ventilation flue 15 is opened by the second damper 19, the foot-side ventilation flue 16 is opened by the third damper 20, and the defroster-side ventilation flue 17 is closed by the fourth damper 21. As a result, some air that was cooled by the evaporator 11 flows to the face-side ventilation flue 15 from the outlet-side ventilation flue 12 and is blown out into the cabin from the first and second face air outlets 4 and 5. Further, the other air that was cooled by the evaporator 11 is heated by the heater 13 inside the heater-side ventilation flue 14, flows to the foot-side ventilation flue 16 from the outlet-side ventilation flue 12, and is blown out into foot space inside the cabin from the foot air outlets 6.

In a foot mode, as shown in FIG. 12, the outlet-side ventilation flue 12 is closed and the heater-side ventilation flue 14 is opened by the first damper 18, the face-side ventilation flue 15 is closed by the second damper 19, the foot-side ventilation flue 16 is opened by the third damper 20, and the defroster-side ventilation flue 17 is closed by the fourth damper 21. As a result, air that flowed out from the evaporator 11 is heated by the heater 13 inside the heater-side ventilation flue 14, flows to the foot-side ventilation flue 16 from the outlet-side ventilation flue 12, and is blown out to the feet of an occupant from the foot air outlets 6. As a result, the cabin is mainly heated by air that is blown out into foot space. At this time, by opening the defroster-side ventilation flue 17 slightly by means of the fourth damper 21, a small quantity of the air in the outlet-side ventilation flue 12 flows to the defroster-side ventilation flue 17 and is blown out to the inner side of the windshield from the defroster air outlet 7. Thus, a windshield defogging effect can also be obtained by means of the small quantity of air that is blown out from the defroster air outlet 7.

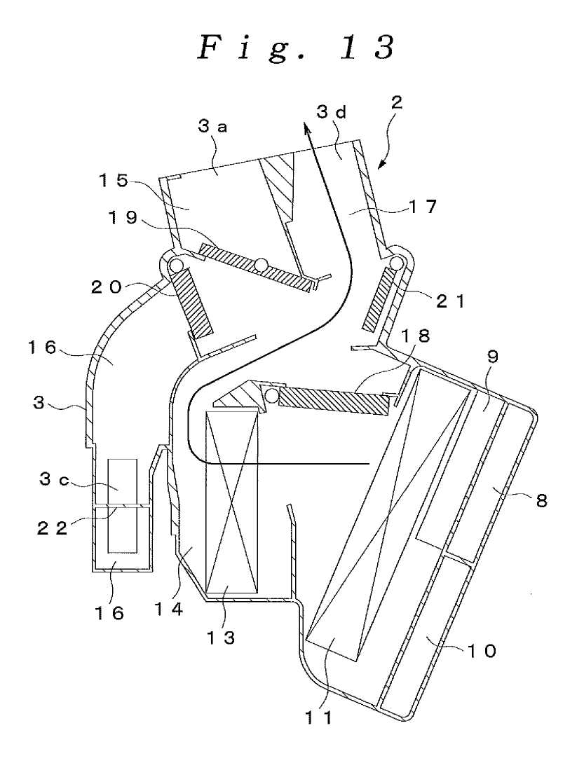

In a defroster mode, as shown in FIG. 13, the outlet-side ventilation flue 12 is closed and the heater-side ventilation flue 14 is opened by the first damper 18, the face-side ventilation flue 15 is closed by the second damper 19, the foot-side ventilation flue 16 is closed by the third damper 20, and the defroster-side ventilation flue 17 is opened by the fourth damper 21. As a result, air that was cooled (dehumidified) by the evaporator 11 is heated by the heater 13 inside the heater-side ventilation flue 14, flows to the defroster-side ventilation flue from the outlet-side ventilation flue 12, and is blown out towards the windshield from the defroster air outlet 7.

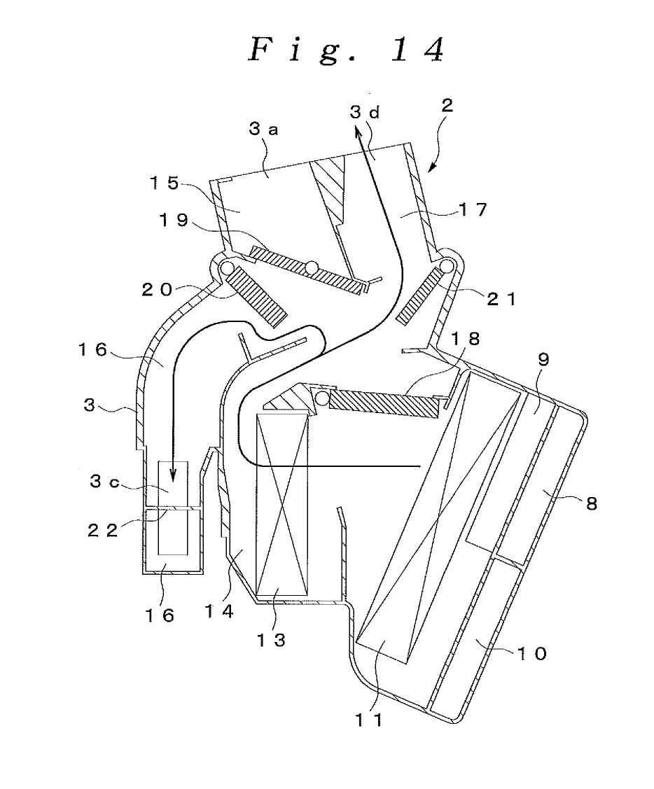

In a foot/defroster mode, as shown in FIG. 14, the outlet-side ventilation flue 12 is closed and the heater-side ventilation flue 14 is opened by the first damper 18, the face-side ventilation flue 15 is closed by the second damper 19, the foot-side ventilation flue 16 is opened by the third damper 20, and the defroster-side ventilation flue 17 is opened by the fourth damper 21. As a result, air that flowed out from the evaporator 11 is heated by the heater 13 inside the heater-side ventilation flue 14, some of the air flows to the foot-side ventilation flue 16 from the outlet-side ventilation flue 12 and is blown out into foot space inside the cabin from the foot air outlets 6. Further, the other air flows to the defroster-side ventilation flue 17 from the outlet-side ventilation flue 12 and is blown out towards the windshield from the defroster air outlet 7.

Thus, according to the vehicle air conditioning device of the present embodiment, in a configuration in which the first damper 18 that opens/closes the downstream side of the evaporator 11 is formed so as to span the evaporator 11 in the width direction and rotates around the spindle 18a that extends in the width direction of the evaporator 11, because the first and second outside air ventilation flues 8 and 9 are formed so that outside air flows through one end side and the other end side in the width direction of the evaporator 11, respectively, and the inside air ventilation flue 10 is formed so that inside air flows through the central site in the width direction of the evaporator 11, at any degree of opening of the first damper 18, outside air from the respective outside air ventilation flues 8 and 9 and inside air from the inside air ventilation flue 10 can be caused to flow to the outlet-side ventilation flue 12 side or the heater-side ventilation flue 14 side at a flow rate that corresponds to the degree of opening of the first damper 18, respectively. That is, even in the configuration in which outside air and inside air are caused to flow to the evaporator 11, respectively, it is not necessary to provide the first damper 18 that opens/closes the downstream side of the evaporator 11 for each of the outside air and inside air flow sections, respectively, and thus the number of dampers can be reduced to thereby simplify the structure and lower the manufacturing cost.

In addition, since a configuration is adopted so that outside air in the first and second outside air ventilation flues 8 and 9 flows through one end side and the other end side in the width direction of the evaporator 11, respectively, and inside air in the inside air ventilation flue 10 flows through the central site in the width direction of the evaporator 11, outside air can be caused to flow to both sides in the width direction of the unit body 3 and inside air can be caused to flow to the central site in the width direction of the unit body 3, and thus the outside air and inside air can be caused to flow in a well-balanced manner with respect to the left and right sides inside the unit body 3.

In this case, since a configuration is adopted in which the first and second outside air ventilation flues 8 and 9 of the unit body 3 communicate with the upper ventilation flue lb of the duct 1a from the blower unit 1, and the inside air ventilation flue 10 of the unit body 3 communicates with the lower ventilation flue 1c of the duct 1a, because the blower unit 1 is normally provided with a single outside air intake port and a single inside air intake port (not shown in the drawings), the upper ventilation flue lb and the lower ventilation flue 1c can be easily communicated with these intake ports, and thus the structure can be simplified.

Further, since the air inflow sides of the respective outside air ventilation flues 8 and 9 and the inside air ventilation flue 10 are formed so that air flows therein from one side in the width direction of the vehicle towards the other side, and the air outflow sides are formed so that air flows out in the front-and-rear direction of the vehicle towards the evaporator 11, even in a vehicle with a structure in which the blower unit 1 is disposed on one side of the air conditioning unit 2, the blower unit 1 and the air conditioning unit 2 can be easily connected, and an occupying space of the duct la that connects the blower unit 1 and the air conditioning unit 2 can be decreased.

In addition, since the respective outside air ventilation flues 8 and 9 and the inside air ventilation flue 10 are arranged so as to be positioned above and below each other, the outside air ventilation flue and inside air ventilation flue of the duct la that sends air from the blower unit 1 to the air conditioning unit 2 can also be disposed so as to be positioned above and below each other, and thus a dimension in the front-and-rear direction of the duct 1a can be reduced.

In this case, since the first outside air ventilation flue 8 through which air flows out to one end side in the width direction of the evaporator 11, and the second outside air ventilation flue 9 through which air flows out to the other end side in the width direction of the evaporator 11 are provided so as to adjoin each other in the front-and-rear direction of the vehicle, even when the upper ventilation flue 1b and the lower ventilation flue 1c of the duct la are provided at the upper part and lower part of the duct 1a, respectively, the first and second outside air ventilation flues 8 and 9 can be easily communicated with the upper ventilation flue 1b of the duct 1a. There is thus the advantage that even when the two outside air ventilation flues 8 and 9 are provided on a unit body 21 side, the structure of the duct la between the two outside air ventilation flues 8 and 9 and the blower unit 1 is not complicated.

In addition, since each of the outside air ventilation flues 8 and 9 and the inside air ventilation flue 10 are formed in a flattened shape so that the respective widths thereof in the front-and-rear direction of the vehicle are less than a dimension in the vertical direction, a depth dimension of the unit body 21 can be decreased and the size of the unit body 21 can be reduced.

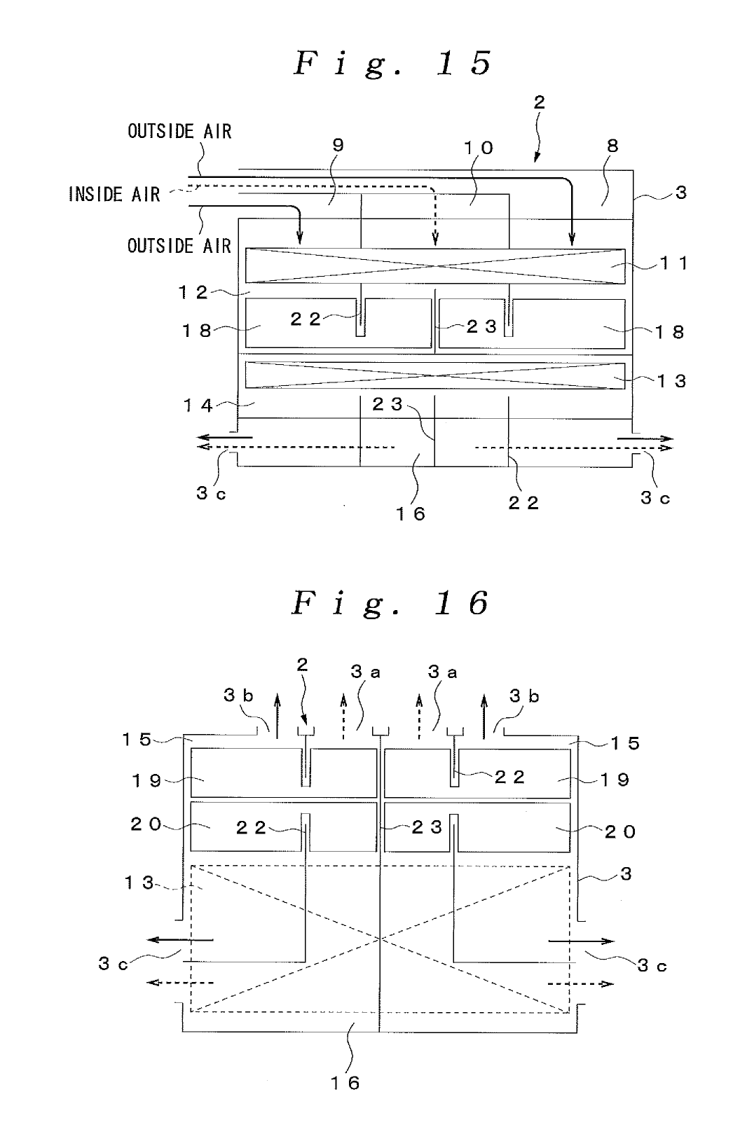

FIG. 15 and FIG. 16 illustrate another embodiment of the present invention, in which component parts that are equivalent to component parts in the above described embodiment are denoted by the same reference symbols. Note that since the configuration other than the configuration shown in FIG. 15 and FIG. 16 is identical to the above described embodiment, an illustration thereof is omitted from the drawings.

According to the present embodiment, the inside of the air conditioning unit 2 is partitioned at the center in the width direction by a partition wall 23, and the first, second, and third dampers 18, 19, and 20 are respectively divided for each of a left and a right ventilation flue that are partitioned by the partition wall 23. In this case, the first, second, and third dampers 18, 19, and 20 are respectively capable of operating independently in each of the left and right ventilation flues.

According to the present embodiment, by adjusting the first, second and third dampers 18, 19 and 20 to an arbitrary degree of opening for each of the left and right ventilation flues, for example, air that is blown out to the driver's seat side and air that is blown out to the front passenger seat side can be controlled to different temperatures according to the preferences of the occupants or the heat load, and thus air conditioning inside the cabin can be performed more accurately.

Note that, although according to the above described embodiment a configuration was described in which outside air flows out to one end side and the other end side in the width direction of the evaporator 11 from the respective outside air ventilation flues 8 and 9, and inside air flows out to the central site in the width direction of the evaporator 11 from the inside air ventilation flue 10, the present invention is not limited to that configuration. For example, a configuration may also be adopted in which inside air flows out to one end side and the other end side in the width direction of the evaporator 11 and inside air also flows out to the central site in the width direction of the evaporator 11, or in which outside air flows out to one of the one end side and the other end side in the width direction of the evaporator 11 and inside air flows out to the other of the one end side and the other end side in the width direction of the evaporator 11.

Furthermore, although according to the above described embodiment a configuration was described that includes the heater through which cooling water of the radiator of the vehicle flows, a heater that uses a heat source other than cooling water of a radiator can also be used. For example, a configuration may be adopted that uses an electric heater that is driven by the electric power of a battery, or in which a radiator through which high temperature refrigerant of a refrigerant circuit to which the evaporator 11 is connected flows is used as a heater. Further, a configuration may be adopted in which a circuit is provided through which a heating medium such as water or brine flows, and in which the heated heating medium flows to a heat exchanger as a heater. By using such kinds of heaters, for example, the present invention is advantageous for a vehicle in which there is no engine to serve as a heat source, such as an electric automobile, or a vehicle in which an adequate heat amount for heating can not be secured by means of only the waste heat of the engine, such as a hybrid car.

### REFERENCE SIGNS LIST

8 . . . first outside air ventilation flue, 9 . . . second outside air ventilation flue, 10 . . . inside air ventilation flue, 11 . . . evaporator, 12 . . . outlet-side ventilation flue, 13 . . . heater, 14 . . . heater-side ventilation flue, 18 . . . first damper, 23 . . . partition wall

1. A vehicle air conditioning device, comprising:
an outside air ventilation flue through which outside air that is sucked in from outside a cabin of a vehicle flows;
an inside air ventilation flue through which inside air that is sucked in from inside the cabin of the vehicle flows; an evaporator that is disposed on a downstream side of the outside air ventilation flue and the inside air ventilation flue;
an outlet-side ventilation flue through which air that flows out from the evaporator flows;
a heater that is disposed on a downstream side of the evaporator;
a heater-side ventilation flue that causes air that flows out from the evaporator to flow via the heater to the outlet-side ventilation flue; and
a damper that is formed so as to span the evaporator in a width direction on the downstream side of the evaporator, and that, by rotating around a shaft extending in the width direction of the evaporator, opens/closes a flow path of air that flows directly to the outlet-side ventilation flue from the evaporator and a flow path of air that flows from the evaporator via the heater-side ventilation flue to the outlet-side ventilation flue, respectively,
wherein:
the outside air ventilation flue is formed so that the outside air flows to a predetermined position in the width direction of the evaporator; and
the inside air ventilation flue is formed so that the inside air flows to another predetermined position in the width direction of the evaporator.

2. The vehicle air conditioning device according to claim 1, wherein:
the outside air ventilation flue is formed so that outside air flows to one end side and the other end side in the width direction of the evaporator; and
the inside air ventilation flue is formed so that inside air flows to a central site in the width direction of the evaporator.

3. The vehicle air conditioning device according to claim 1, wherein:
an air inflow side of the outside air ventilation flue and an air inflow side of the inside air ventilation flue is formed so that air flows from one side towards the other side in a width direction of the vehicle, and
an air outflow side of the outside air ventilation flue and an air outflow side of the inside air ventilation flue is formed so that air flows in a front-and-rear direction of the vehicle towards the evaporator.

4. The vehicle air conditioning device according to claim 3, wherein the outside air ventilation flue and the inside air ventilation flue are formed so that the air inflow sides thereof are positioned above and below each other.

5. The vehicle air conditioning device according to claim 4, wherein:
the outside air ventilation flue is formed from a first outside air ventilation flue through which air flows out to one end side in the width direction of the evaporator, and a second outside air ventilation flue through which air flows out to the other end side in the width direction of the evaporator; and
the first outside air ventilation flue and the second outside air ventilation flue are provided so that the air inflow sides thereof adjoin each other in the front-and-rear direction of the vehicle.

6. The vehicle air conditioning device according to claim 3, wherein the outside air ventilation flue and the inside air ventilation flue are formed in a flattened shape so that a width of each in the front-and-rear direction of the vehicle is less than a dimension in a vertical direction.

7. The vehicle air conditioning device according to claim 2, further comprising:
a partition wall that partitions inside of the outlet-side ventilation flue and the heater-side ventilation flue in the width direction of the vehicle;
wherein the damper is configured to be capable of operating independently in each ventilation flue that is partitioned by the partition wall.

8. The vehicle air conditioning device according to claim 3, further comprising:
a partition wall that partitions inside of the outlet-side ventilation flue and the heater-side ventilation flue in the width direction of the vehicle;
wherein the damper is configured to be capable of operating independently in each ventilation flue that is partitioned by the partition wall.

9. The vehicle air conditioning device according to claim 4, further comprising:
a partition wall that partitions inside of the outlet-side ventilation flue and the heater-side ventilation flue in the width direction of the vehicle;
wherein the damper is configured to be capable of operating independently in each ventilation flue that is partitioned by the partition wall.

10. The vehicle air conditioning device according to claim 5, further comprising:
a partition wall that partitions inside of the outlet-side ventilation flue and the heater-side ventilation flue in the width direction of the vehicle;
wherein the damper is configured to be capable of operating independently in each ventilation flue that is partitioned by the partition wall.

11. The vehicle air conditioning device according to claim 6, further comprising:
a partition wall that partitions inside of the outlet-side ventilation flue and the heater-side ventilation flue in the width direction of the vehicle;
wherein the damper is configured to be capable of operating independently in each ventilation flue that is partitioned by the partition wall.
